(19) United States
(12) Patent Application Publication
(10) Pub. No.: US 2005/0177630 A1
(43) Pub. Date: Aug. 11, 2005

(54) Service analysis

(76) Inventor: Masoud Aghadavoodi Jolfaei, Wiesloch (DE)

Correspondence Address: FISH & RICHARDSON, P.C., PO BOX 1022, MINNEAPOLIS, MN, 55440-1022, US

(21) Appl. No.: 10/742,253

(22) Filed: Dec. 19, 2003

(51) Int. Cl. G06F 15/173

(52) U.S. Cl. 709/224

(57) ABSTRACT

Service analysis of a session may be performed at a data distribution device. Systems and techniques for service analysis at a data distribution device may be able to receive a request for service analysis of a session. Additionally, the systems and techniques may be able to determine whether data relevant to the service analysis is available and, if relevant data is available, insert the relevant data in a specified memory.

### BACKGROUND

Large scale business software applications are sometimes categorized in terms of a front end component that includes a graphical user interface (GUI) to present data to users and accept data entry from users. Such front end components are customized for specific customers. Another component of such software applications is sometimes referred to as a back end component, which may store business data and process the business data according to business logic. The back end component retrieves, generates, and maintains the business data. The back end component is usually responsible for the consistency and correctness of the data. The back end component may also store relationships between the various data. In a typical business software application, the front end component includes application code to display and aggregate data of the back end and provides help to generate requests to the back end for update operations.

### SUMMARY

The ability to analyze the interoperations between computing devices, resources, and other computer system components in a large scale business environment allows for the identification of software application errors in the computer system. In particular aspects, the analysis includes recording data regarding the service provided to one computing device by another computing device. The data may include information regarding the handling of a request, the accessing of resources to respond to the request, and the formation of a response with information from the accessed resources. Various aspects and/or combinations of service, however, may be analyzed in other implementations.

In one general aspect, a method for service analysis may be performed at a data distribution device. The method may include receiving a request for service analysis of a session. The method may also include determining whether data relevant to the service analysis is available and, if relevant data is available, inserting the relevant data in a specified memory. Relevant data may include a state of the distribution data device. The method may be performed by hand, machine, instructions operable to cause one or more machines to perform operations, or any other appropriate technique.

In particular implementations, determining whether data relevant to the service analysis is available includes determining whether a request for the session has been received, and inserting the relevant data in a specified memory includes inserting a request in the specified memory if a request for the session has been received. Furthermore, the method may include determining whether the request includes sensitive data and, if the request includes sensitive data, removing the sensitive data before inserting the request in the specified memory. A request may, for example, be a Hypertext Transfer Protocol request.

In certain implementations, determining whether data relevant to the service analysis is available includes determining whether a response for the session has been received, and inserting the relevant data in a specified memory includes inserting a response in the specified memory if a response for the session has been received. Additionally, the method may include determining whether the response includes sensitive data and, if the response includes sensitive data, removing the sensitive data before inserting the response in the specified memory.

Certain implementations may include determining a level of recordation for the service analysis and inserting data for the service analysis into the specified memory based on the level.

Some implementations may include receiving a request to access the inserted data, determining whether a user associated with the request is authorized to access the inserted data, and, if a user associated with the request is authorized to access the inserted data, allowing access to the inserted data. Allowing access to the inserted data may include generating a user interface to display the inserted data, allowing execution of a request in the inserted data, allowing modification of a storage time for the inserted data, and/or allowing modification of the inserted data.

In another general aspect, a method for service analysis at a data distribution device may include receiving a request to access service analysis data for a session, determining whether a user associated with the request is authorized to access the data, and, if a user associated with the request is authorized to access the data, allowing access to the data. The data may include a request for the session and/or a data distribution device state. Allowing access to the data may include generating a user interface to display the inserted data, executing a request in the inserted data, allowing modification of the inserted data, and/or allowing modification of a storage time for the inserted data. The method may be performed by hand, machine, instructions operable to cause one or more machines to perform operations, or any other appropriate technique.

In another general aspect, a method for service analysis at a data distribution device includes receiving a request for service analysis of an application session and determining a recordation level for the service analysis. The method also includes determining whether data relevant to the service analysis is available, wherein the relevant data includes a Hypertext Transfer Protocol request for the session and a state of the data distribution device, and, if data relevant to the service analysis is available, determining whether the data is in accordance with the recordation level. The method further includes determining whether the relevant data includes sensitive data if the data is in accordance with the recordation level and removing the sensitive data from the relevant data if the relevant data includes sensitive data. The method also includes inserting the relevant data in a database location, receiving a request to access the inserted data, and determining whether a user associated with the request is authorized to access the inserted data. If a user associated with the request is authorized to access the inserted data, the method calls for allowing access to the inserted data, wherein allowing access includes generating a user interface to display the inserted data, allowing execution of a request in the inserted data, allowing modification of a storage time for the inserted data, and allowing modification of the inserted data.

Particular implementations may have one or more features. For example, by recording the requests and responses associated with an error condition, analysis of the error condition may be enhanced, because user descriptions of the problem, which often tend to be inaccurate or incomplete, no longer have to be relied upon. Moreover, the analysis may include reproduction of the error condition, which further aids analysis. As another example, because recording may be used when an error has occurred, the volume of data stored may be manageable, and any decreased performance by the data distribution device may be small. As an additional example, because a service recorder may be implemented in a data distribution device, information regarding a state of the data distribution device and/or the resources may be identified and stored. Thus, data distribution device and/or resource errors may be more readily identifiable. Also, this may allow the request, response, and state information to be readily assimilated. Moreover, the logon procedure inside the data distribution device may be validated; often, the relevant information about logon procedure is removed from the request after the logon processing due to security issues. Furthermore, sensitive data does not have to be recorded.

### BRIEF DESCRIPTION OF THE DRAWINGS

FIG. 1 is a block diagram of a system for service analysis.

FIG. 2 is a block diagram of a data distribution device for the system of FIG. 1.

FIG. 3 is a flow chart of a process for service analysis.

FIG. 4 is a flow chart of a process for service analysis.

FIG. 5 is a flow chart of a process for service analysis

Like reference numbers and designations in the various drawings indicate like elements.

### DETAILED DESCRIPTION

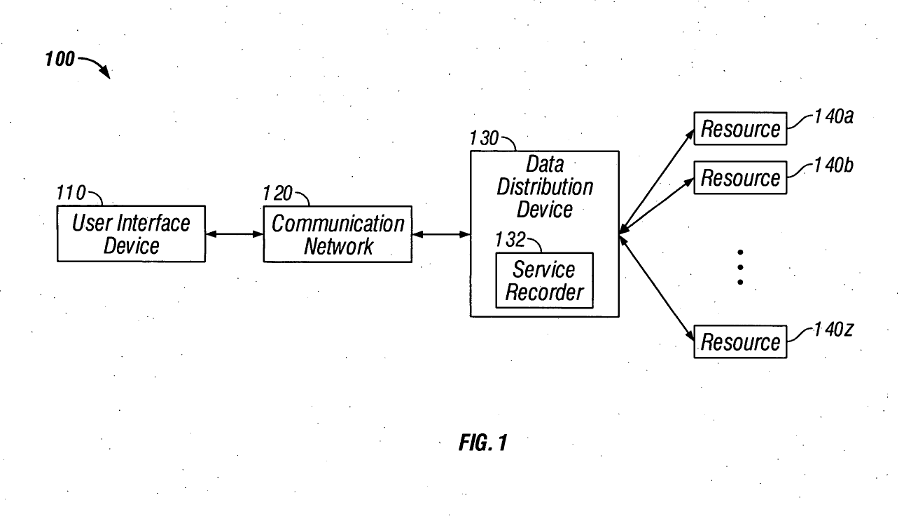

FIG. 1 illustrates a system 100 for service analysis. System 100 includes a user interface device 110, a communication network 120, a data distribution device 130, and resources 140. In general, user interface device 110 uses communication network 120 to send requests to and receive responses from data distribution device 130, which provides data, perhaps after manipulation, from resources 140 to user interface device 110. To assist in analyzing the interaction between user interface device 110, data distribution device 130, and resources 140, in order to identify problems between them, data distribution device 130 is responsible for recording the requests from user interface device 110, information regarding data distribution device 130, information regarding accessed resources 140, information received from accessed resources 140, the responses from data distribution device 130, and/or any other information regarding the handling of requests and responses by the distribution device.

In more detail, user interface device 110 may be any appropriate apparatus for requesting, receiving, and presenting information. In the illustrated implementation, user interface device 110 is operable to request data from one or more of resources 140 through communication network 120 and data distribution device 130. Examples of user interface device 110 include a personal computer (PC), a workstation (WS), a personal digital assistant (PDA), and a cellular telephone. To request, receive, and present information, user interface device 110 may use a Web browser, such as, for example, Netscape Navigator® or Microsoft Internet Explorer®.

Communication network 120, in turn, may be any appropriate system for conveying information between computing devices. In the illustrated implementation, communication network 120 is shown as being directly coupled to user interface device 110 and data distribution device 130. However, there may exist intervening communication components, such as, for example, exchanges, switches, repeaters, and routers, between communication network 120 and the computing devices coupled thereto. Furthermore, communication network 120 may implement wireless techniques for communicating with computing devices. Thus, a computing device may be coupled to communication network 120 without being physically coupled thereto. Examples of communication network 120 include a Public Switched Telephone Network (PSTN), a Personal Communications Service (PCS) network (e.g., IS-95 or IS-136), an X.25 network, and the Internet.

Data distribution device 130 may be any appropriate device for receiving requests from user interface device 110 and providing responses, which may include data from resources 140. To accomplish this data transfer, user interface device 110 and data distribution device 130 may enter into a client-server relationship. Examples of data distribution device 130 include a Web server and an application server. In particular implementations, data distribution device 130 may be a Web Application Server (WAS) from SAP AG of Walldorf, Germany.

Data distribution device 130 includes a service recorder 132. Service recorder 132 is responsible for recording service data regarding sessions between user interface device 110 and data distribution device 130. A session may be a series of interactions between two communication end points during the span of a single connection. Typically, one end point requests a connection with another end point, and, if the second end point replies agreeing to the connection, the end points take turns exchanging commands and data. A session may begin when a connection is established at both ends and terminate when the connection is broken.

Service data may include requests from user interface device 110, information regarding data distribution device 130, information regarding accessed resources 140, information received from accessed resources 140, the responses from data distribution device 130, and/or any other information regarding the handling of requests and responses by the data distribution device. Service recorder 132 may also assist in analyzing the service data by providing access to the data and facilitating execution, tracing, and debugging of the requests.

Resources 140 may be any entities that contain and/or generate information, and from which the information may be requested and/or retrieved. Examples of resources 140 include databases and applications. Resources may, for example, use HyperText Markup Language (HTML) for customer to business communication and Extensible Markup Language (XML) for business to business communication.

In particular modes of operation, user interface device 110 and data distribution device 130 exchange information with each other by the use of open protocols, such as, for example, Hypertext Transfer Protocol (HTTP), Hypertext Transfer Protocol Secure (HTTPS), and/or Simple Mail Transfer Protocol (SMTP). Converter and tunneling mechanisms may or may not be used. HTTP, for instance, may enable data transfer from an Internet client (e.g., a browser) to a server. Using this protocol, user interface device 110 issues requests to data distribution device 130, and data distribution device 130 answers with responses. In other modes of operation, other stateless protocols may be used, or state-preserving protocols may be implemented. Additionally, data distribution device 130 may provide an Advanced Business Application Programming (ABAP) interface to resources 140.

To activate service analysis functions of data distribution device 130, user interface device 110 issues a request for service analysis, which may include a description of a session to be analyzed. Examples of sessions include application sessions, client-server sessions, communication sessions, and database access sessions. Upon receiving the service analysis request, data distribution device 130 determines whether the request is acceptable. The request may not be acceptable if user interface device 110, or associated user, that initiated the request cannot be authenticated or if user interface device 110, or associated user, is not authorized to use the service. Authentication and authorization may take place using any appropriate technique, such as, for example, X.509 certificates and roles, respectively.

If the request for service analysis is acceptable, service recorder 132 determines a memory location for storing service information regarding the session. The memory location may, for example, be an entry in a database, and may store data about requests from user interface device 110, about data distribution device 130, about resources 140, and/or about responses from data distribution device 130. The information about data distribution device 130 and about resources 140 may include information about the logon procedure, the linking between the request and the resources, the information given to the resources, and where an error occurred (e.g., in the data distribution device or in a resource). The entry may have been previously created in the database.

Once the memory location is specified, data distribution device 130 begins to store data about the session at the memory location. In particular implementations, user interface device 110 specifies different levels of recordation for the service analysis. The level of recordation may depend on the type of error previously encountered by user interface device 110.

In certain implementations, for example, three levels of service recordation may be provided by data distribution device 130. The first level may be used to record information when problems occur with logging on to data distribution device 130. Thus, only the initial request from user interface device 110 and information about an initial state of data distribution device 130 may be required. The second level may be used when no meaningful response, such as, for example, a dump, is returned by data distribution device 130 in response to a request. Thus, only the request and a state of data distribution device 130 may be required. The third level may be used when erroneous information is returned by data distribution device 130 in response to a request, for example, an incorrect form returned in response to a request. This level may provide for recording of requests, a state of data distribution device 130, a state of one of resources 140, and responses from data distribution device 130. The responses could include a dump.

Data distribution device 130 may also protect sensitive data by removing it before it may be stored at the memory location. Thus, the chance of sensitive data being improperly obtained due to the recordation is reduced.

Service recorder 132 may continue to analyze the entries in data distribution device 130 that are to be recorded based on the chosen recordation level and store parts of the analysis, or other data about the session, until a designated event happens. One example of a designated event is when the session reaches a point at which an error occurs.

Once the service analysis data for the session is recorded, service recorder 132 may assist in analyzing the data for the cause of errors. For example, the service recorder may allow developers and support employees to use the infrastructure of data distribution device 130 to analyze error situations. The assistance may include generating a user interface to display the data (e.g., logon method, request URL (Uniform Resource Locator), request header, response URL, and response header) and executing the requests in the data. Executing the requests may also include features like debuggers and work-process traces. For instance, a debugger may be used to evaluate the execution of ABAP reports, and a trace may be used to analyze the execution of ABAP statements and applications in the Kernel. Also, executing the requests may be used to evaluate operations after correcting errors, by Kernel or ABAP corrections, for example. The assistance may further include editing the data. Editing may include changing data, deleting data, and/or copying data.

Service recorder 132 may also assist in performing other operations on the data. For example, the service recorder may allow downloading (e.g., exporting) of data and uploading (e.g., importing) of data, which may have been previously exported. Furthermore, the service recorder may allow administration of the data. For instance, the service recorder may allow modification of the storage time of a set of data, each data set for a session having a storage time to avoid excessive storage requirements. A data set may or may not be deleted automatically after the expiration of the storage time.

System 100 has several features. For example, by recording the requests and responses associated with an error condition, analysis of the error condition, which may include reproduction, is enhanced, because user descriptions of the problem, which often tend to be inaccurate or incomplete, no longer have to be relied upon. As another example, because the recording is typically only used when an error has occurred, the volume of data stored should be manageable, and any decreased performance by data distribution device 130 should be small. As an additional example, because service recorder 132 is implemented in the data distribution device, information regarding a state of the data distribution device and/or the resources may be identified and stored. Thus, data distribution device and/or resource errors should be more readily identifiable. Also, this implementation allows the request, response, and state information to be readily assimilated. Moreover, the logon procedure inside the data distribution device may be validated; often, the relevant information about logon procedure is removed from the request after the logon processing due to security issues. Furthermore, sensitive data does not have to be recorded. Additionally, the error analysis tools of the data distribution device, such as, for example, debugging, tracing, ABAP runtime analysis, may be utilized. As a further example, by controlling the processing of recorded data, security of the error correction process may be provided by the maintenance of a security log, which may record all operations on a data set. A system log may also be used.

In particular implementations, data distribution device 130 may require authorization to access the recorded data, which further enhances security. Administrators may, for example, determine access restrictions and assign the necessary authorizations for developers and support employees to access the data. Furthermore, the authorizations may be more detailed; for example, the operations on data (e.g., download, upload, and execution) may have additional authorizations. Additional security may be provided by using a security audit after a successful authorization. Activities may be recorded on single entries, not only in a security log, but also in a system log. This may allow an administrator to determine the storage times of single entries.

Although system 100 illustrates one implementation of a system for service analysis, other systems for service analysis may have fewer, additional, and/or a different arrangement of components. For example, a system for service analysis may have a number and variety of user interface devices interacting with data distribution device 130 through communication network 120. As another example, a system for service analysis may have multiple data distribution devices, arranged serially and/or in parallel. As a further example, a system for service analysis may have only one resource.

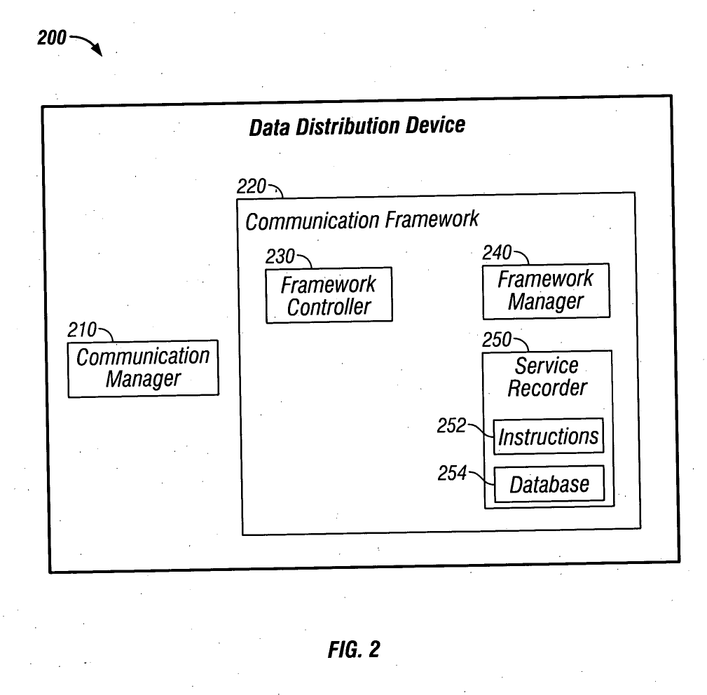

FIG. 2 illustrates a data distribution device 200 that may be used in system 100. As illustrated, data distribution device 200 includes a communication manager 210 and a communication framework 220. In general, communication manager 210 is responsible for handling the low-level (e.g., network layer) communication of requests from and responses to a remote computing device, and communication framework 220 is responsible for processing the information in the requests and generating the information for the responses.

In more detail, communication manager 210 may provide Internet communication management in certain implementations. As such, it may handle the receipt and distribution of Transfer Control Protocol (TCP) messages between data distribution device 200 and a remote computing device, like user interface device 110 in FIG. 1. The communication manager 210 may dispatch requests (e.g., HTTP requests) to a processing engine (e.g., a Java 2 Platform, Enterprise Edition (J2EE) engine or an ABAP engine) depending of the request URL. In some implementations, communication manager 210 and communication framework 220 may be part of an ABAP engine, at least at runtime.

Communication framework 220 includes a framework controller 230, a framework manager 240, and a service recorder 250. Framework controller 230 and framework manager 240 may work together to provide an ABAP programming interface for accessing an HTTP infrastructure (e.g., communication manager 210). Framework controller 230 and framework manager 240 may also provide Web Service definition and advanced infrastructure services on top of HTTP. These services may include authentication, authorization, debugging, transaction modeling, and virtual hosting. Framework controller 230 and framework manager 240 may additionally provide a basis for applications (e.g., execution of services based on HTTP/HTTPS/SMTP requests). A message handler may be reached at the framework via a URL. Framework controller 230 and/or framework manager 240 may identify and call the message handler. The message handler may be an ABAP class that is bound to a path through the infrastructure of communication framework 220. The URL can also address the message. Furthermore, the framework can link URLs to applications that are to act as resources. This may include reserving links and establishing applications.

Data distribution device 200 may have a data distribution device infrastructure and a client infrastructure for handling these operations. For authentication, the data distribution device infrastructure may include basic authentication (e.g., alias name support), form or header fields, user service as anonymous account, Single Sign On (SSO), X.509 client certification, and Remote Function Call (RFC) logon (e.g., for R/3 communication). For authorization, the data distribution device infrastructure may include an authorization object per path prefix. For virtual hosting, the data distribution device infrastructure may include configuration based on host names and port number.

The data distribution device infrastructure may also address context related issues, debugging, and error handling. Context related issues may include stateless, stateful, and/or context pooling. Debugging may include debugger activation/deactivation, and transfer of user break points into a debugging session. Error handling may include customizable error templates per service and ABAP runtime error processing.

The client infrastructure may provide automatic redirection (e.g., by receiving 301/302 status codes) and generate an automatic logon prompt (e.g., by receiving a 401 status code). Furthermore, the client infrastructure may be able to maintain logon data, via form fields or header fields, via an authentication mechanism at runtime, or via destination (e.g., authority check for destination or trusted system authentication). The client infrastructure may also provide cookie handling (e.g., cookie is accepted, cookie is rejected, pop-up for acceptance or rejection, or handling of cookies via an event handler) and timeout per request.

The client infrastructure may be a client object. The client object may be generated by specifying the host, service, proxy_host, and proxy_service. The result may be an interface reference for the new object. The client object may also be generated based on destination. The interface reference may contain a request attribute (i.e., type reference of request), which may be operable to generate a request document (e.g., header and body), and a response attribute (i.e., type reference of response), which may be operable to access a response document. Methods of the interface may, for example, include send, receive, listen, and close.

Service recorder 250 includes instructions 252 and a database 254. Instructions 252 are logical constructs that dictate how the service analysis operations work. Database 254 stores service analysis data identified by instructions 252. Database 254 may be self-contained for audit reasons. Instructions 252 and database 254 are stored on computer readable media, which may include random access memory (RAM), read-only memory (ROM), compact-disk read-only memory (CD-ROM), registers, and/or any other appropriate information storage device.

In one mode of operation, when communication manager 210 receives a new HTTP request, it instantiates framework controller 230. The framework controller analyzes the request to determine whether access to a resource is required. If access to a resource is required, the framework controller instantiates framework manager 240. The framework manager checks whether debugging, tracing, and/or service analysis has been activated and, if so, initiates the appropriate tasks.

If service analysis has been activated, service recorder 250 determines whether logon has been successfully completed. If not, the service recorder assigns an entry in database 252 and records appropriate data (e.g., request path and the response page) therein. If, however, logon has been successfully completed, the service recorder assigns an entry in the database and records the request and logon information therein.

Table 1 below illustrates a data entry in the recorder regarding the data distribution device. Table 2 below illustrates a data entry in the recorder regarding logon. The data includes the name of the data distribution device where the request was executed and the execution time. An example of another entry in the recorder is shown in Table 3 below.

TABLE 1
Example Data Distribution Device Data in Entry

| Protocol | Data |
|---|---|
| ID | 0A114BF56E323F9E74C2015000000000 (GUID |
| | used for framework record entry in the database) |
| Request-Pfad | /sap/bc/bsp/sap/icf/menu.htm (Request path) |
| Host | 0 (Addressed virtual host in ICF runtime) |
| Response-Status | 200 OK |

TABLE 2
Example Logon Data in Entry

| Logon | Value |
|---|---|
| Server | 1s0347_BIN_53 (data distribution device) |
| User | AGHADAVOODI |
| Language | D |
| UTC | 20.031.028.135.306, 9903310 (time stamp of |
| | data distribution device) |
| Method | 2 (used logon method in framework runtime) |

TABLE 3
Example Database Entry

| Parameter Name | Parameter Value |
|---|---|
| LOGON_CLIENT | 000 |
| MESSAGE_ID | 0A155098723C3F98D366003300000000 |
| MESSAGE_TYPE | I |
| MESSAGE_ROLE | SE |
| STATUS | |
| SYSTEM_ID | B4A |
| LOGON_SERVER | 1d0004_B4A_04 |
| LOGON_USER | AGHADAVOODI |
| LOGON_LANGUAGE | D |
| LOGON_TIMESTAMP | 20031024072318.7516990 |
| LOGON_METHOD | 2 |
| LOGON_FAILED | |
| EXPIRE_TIMESTAMP | 20031024152318.0000000 |
| KEEP_MESSAGE | |
| SCRAMBLE_KEY | |
| OWNER_SERVER | 1d0004_B4A_04 |
| OWNER_CLIENT | 000 |
| OWNER_USER | AGHADAVOODI |
| OWNER_LANGUAGE | |
| OWNER_TIMESTAMP | 0.0000000 |
| SCOPE_MESSAGEID | 0A114BF50FB63F97A463088E00000000 |
| SCOPE_MESSAGENR | 38 |
| CALLER_MESSAGEID | |
| ROOT_MESSAGEID | 0A155098723C3F98D366003300000000 |
| PARENT_MESSAGEID | |
| OBJECT_ID | 0A155098723C3F98D366003300000000 |
| OBJECT_COUNTER | 1 |
| STATEFUL | |
| REQUEST_PROTOCOL | 1 |
| REQUEST_HOST | 1d0004.wdf.sap.corp |
| REQUEST_PORT | 50004 |
| REQUEST_PATH | /sap/bc/echo |
| REQUEST_VHOST | 0 |
| REQUEST | <binary data> |
| RESPONSE_STATUS | 200 OK |
| RESPONSE | <binary data> |
| RESPONSE_TSTAMP | 20031024072318.7710870 |
| ATTRIBUTES | <binary data> |
| LICENSE_NUMBER | |
| SRC_LOGON_CLIENT | |
| SRC_LOGON_USER | |
| SRC_MESSAGEID | |
| SRC_PMESSAGEID | |
| SRC_RMESSAGEID | |
| SRC_SMESSAGEID | |
| SRC_CMESSAGEID | |
| SIGNATURE_METHOD | |
| SRC_SIGNATURE | |
| EXTERNAL_MESSAGE | |
| PROTOCOL_ACTION | X |
| TRACE_LEVEL | 5 |
| REFERENCE_TSTAMP | 20031024072318.7516990 |
| MODIFIED_SYSTEM | |
| MODIFIED_SYSTEM | |
| MODIFIED_CLIENT | |
| MODIFIED_USER | |
| MODIFIED_TSTAMP | 0.0000000 |
| PARTNER_TYPE | Mozilla/4.0 (compatible; MSIE 6.0; |
| | Windows NT 5.0; .NET CLR 1.1.4322) |

Service recorder 250 may also determine whether data regarding the data distribution device should be recorded in the database. The data may describe a state of the data distribution device. For example, the execution of a request in communication framework 220 may include of several parts. The service recorder may store the used protocol (e.g., in the form of uri scheme, which may be HTTP or HTTPS), client IP address, and fields that are used internally to find the internal path to the service and application classes associated with the request.

Furthermore, the type of data to be stored in database 254 may be determined based on the request path. In general, the request path of an HTTP/HTTPS request identifies the requested services in a server. This may also be used to identify the requested services in communication framework 220. A communication framework application may typically know its service node inside the communication framework and also the associated path leading to it. Based on this information, an administrator/developer is able to activate certain functions (e.g., debugging, tracing, ABAP runtime analysis, and service analysis) for requests that use the path.

An example of information stored in the database during the execution of a request is shown in Table 4. This information could be generated in response to executing a request in the form of http://<host>:<port>/<path>.

TABLE 4
Example Database Entry

| Range | Index | Name | Value |
|---|---|---|---|
| 2 | 1 | ˜remote_addr | 10.18.92.116 |
| 2 | 1 | ˜uri_scheme | http |
| 2 | 2 | IF_HTTP_EXTENSION | CL_HTTP_EXT_BSP |
| | | | (Application class used for |
| | | | the path) |
| 2 | 2 | ˜PATH_INFO | /sap/icf/Menu.htm |
| 2 | 2 | ˜PATH_INFO_EXPANDED | /sap/icf/Menu.htm |
| 2 | 2 | ˜PATH_TRANSLATED_EXPANDED | /sap/bc/bsp/sap/icf/Menu.htm |
| 2 | 2 | ˜SCRIPT_NAME | /sap/bc/bsp |
| 2 | 2 | ˜SCRIPT_NAME_EXPANDED | /sap/bc/bsp |
| 7 | 1 | REQUEST_BODY_LENGTH | 20 |
| 7 | 2 | DATABASE_REQUEST_LENGTH | 1464 |
| 7 | 3 | RESPONSE_BODY_LENGTH | 20 |
| 7 | 4 | DATABASE_RESPONSE_LENGTH | 7326 |

Additionally, service recorder 250 looks for requests or responses associated the initial request. If it detects such, it also records those in database 254.

As mentioned previously, service recorder 250 can record service-related data using different levels. For example, the service recorder can be activated depending on the request path to analyze logon errors. If a logon error occurs for the set path-prefix, the logon method and all necessary data for an analysis are recorded, except possibly for sensitive data. As another example, the service recorder can be activated depending on the request-path and user to analyze application errors. To do this, the requests in question are assigned to an identifier after a successful logon and stored in database 254 for further analysis. Operations may then be performed on these entries, like display, execute, download, change, and delete, according to available authorization. As a further example, the service recorder can be activated depending on the request-path and user to analyze request and response errors. As with the application errors, the requests in question are assigned to an identifier after a successful logon and stored in the database for further analysis. Operations may then be performed on these entries, according to available authorization.

To provide security, service recorder 250 deletes sensitive data from the data to be stored before the data is inserted into database 254. Sensitive data may, for example, include a user's and/or an organization's private and/or security information (e.g., social security number, credit card number, personal identification number (PIN), password, or single sign on (SSO) ticket) or any other information that should not be available to others. Sensitive data may only be deleted from the logon data of a request (i.e., the content of the request's body may be uncontrolled).

Data distribution device 200 may also provide security by requiring those attempting to access service analysis data to be authorized. The authorization may take place by using passwords, roles, or any other appropriate authorization techniques. For example, service analysis may be activated and deactivated for all users who have an authorization to execute a transaction communication framework, which will be discussed in more detail below. For instance, all users who have been authorized to execute the transaction communication framework can inspect recordings made as the result of a failed logon. Such entries typically do not contain the content of the request, but only the content of the data distribution device logon error. Moreover, these entries are usually not user interface device dependent. Thus, all entries that have been recorded to analyze logon errors may be processed comprehensively, regardless of the user interface device.

As a default, users may be allowed to perform all operations on their entries without additional authorization. An entry pertains to a user if the user stored it in database 254 after executing a successful logon. But, as discussed previously, an entry stored as the result of a failed logon may be processed by any user, especially if such entries do not contain the content of the request, but the content of the logon error. For the processing of entries that belong to a different user, however, a new authorization for the intended action (display, execute, delete, download, administer, change, and/or copy) may be generated, in the master record, for example. A new authorization object with appropriate roles may be provided for this purpose.

Once the data has been stored in an entry, service recorder 250 assists in analyzing any errors. For example, the service recorder may provide access to methods for viewing the entry and executing, or replaying, the requests in the entry. The assistance may further include editing the entry. Editing may include changing an entry, deleting an entry, or copying an entry.

Service recorder 250 also assists in managing the entries. For example, the service recorder may track the time that an entry has been stored. If an entry is stored for a prolonged period, the entry may be deleted.

Service recorder 250 may also assist in performing other operations on an entry. For example, data distribution device 200 may allow downloading (e.g., exporting) of an entry and uploading (e.g., importing) of an entry. Furthermore, the service recorder may allow administration of the entry. For instance, the data distribution device may allow modification of the storage time of an entry. These operations, as well as those previously discussed, may be applied to a single entry or a group of entries.

As with other error analysis functions (e.g., tracing, debugging, and runtime analysis), service recorder 250 may be activated and deactivated for users who have an authorization to execute functions of data distribution device 200. In particular implementations, only an additional authorization (e.g., a transaction code) to work on the stored entries is needed. An administrator, however, can prohibit uploading, downloading, and executing of entries. In general, though, a user can perform all actions on his entries without additional authorization.

Data distribution device 200 may also allow for the execution of actions on foreign entries (i.e., entries from other systems). To check the authorization to execute actions on foreign entries, the data distribution device may use an authorization object with the attributes activity, user, client, and system. An authority check is performed if a user wants to process the entries of another user.

In particular implementations, after importing an entry into service recorder 250—by an upload action, for example, the entry may be stored under the identity of the user who performed the importation. To process the entry in the new system, a user, including the one who performed the importation, may have to have the authorization to execute the same actions as the original user in the original system. Entries that have been generated as a result of a logon error, however, may be excluded from this.

If a user under a certain client and in a certain system wants to perform an activity (e.g., display, execute, etc.) on a certain service recorder entry of another user in the same system, he may have to have the authorization to perform this activity on this certain recorder entry. Additionally, a user who wants to export and re-import his own recorder entries may be required to have the necessary authorization because each recorder entry that leaves the system may be treated as a “foreign” entry, even if it was created by the same user. For “foreign” entries, a user may have to give the name of the user, name of the client, and the system identifier.

The authorization concept may be arranged hierarchically. For example, every user may be able to work with his own recorder entries in the same logical system (e.g., same client and system). A logical system may include the client name and system name. Additional authorization may be required to view entries from other users in the same logical system (e.g., same client and other system). Further authorization may be required to view “foreign” entries from a different logical system (e.g., same client and different system, different client and same system, or different client and different system).

As mentioned previously, certain implementations may include a transaction communication framework. In the transaction communication framework, communication framework services may be maintained. For example, Web applications that use the HTTP/HTTPS/SMTP protocols may have a service entry in the transaction framework where a customer/administrator/developer can define/modify certain attributes of the services (e.g., logon procedure, authority checks, error templates, and/or compression). In particular implementations, the activation of the error analysis function may take place via the transaction communication framework. Thus, the activation and deactivation of service recorder 250 may be performed by users who have the authorization to execute the transaction communication framework. The activation may be performed via entering the request service function, which may be somewhat analogous to the activation of trace and runtime analyses, or user.

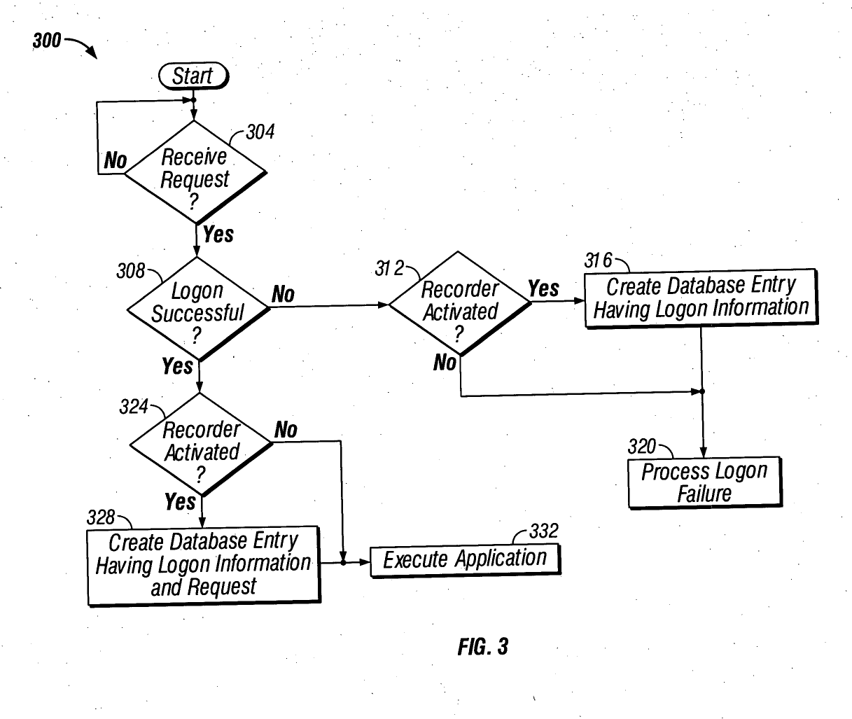

FIG. 3 illustrates a process 300 for service analysis. Process 300 may be implemented by a data distribution device similar to data distribution device 200 in FIG. 2; other data distribution devices, however, may also implement the process.

Process 300 begins with waiting to receive a request for an application session (decision block 304). The request may come from a remote computing device, a local computing device, a system administration module, or any other appropriate system component. The request may have been generated at the behest of a user of a service.

The process continues with determining whether the logon process was successful (decision block 308 ). The logon process may include processing the settings in the request and using authentication, authorization, and/or any other appropriate registration technique.

If the logon was not successful, the process calls for determining whether a service recorder is activated (decision block 312). This determination may be made based on the path, a user activated identifier, and/or any other appropriate basis. If the service recorder is activated, the process call for creating a database entry having logon information (function block 316). After creating the database entry, or if the service recorder is not activated, the process also calls for processing the logon failure (function block 320).

Returning to decision block 308, if the logon was successful, the process calls for determining whether the service recorder is activated (decision block 324). This determination may be made based on the path, a user activated identifier, and/or any other appropriate basis. If the service recorder is activated, the process calls for creating a database entry having logon information and the request (function block 328). The logon information and the request may be merged into one entry. After creating the database entry, or if the service recorder is not activated, the process also calls for executing the application (function block 332). During the execution, a response associated with the request and/or other requests and responses associated with the request may be inserted in the database.

Although FIG. 3 illustrates a process for service analysis, other processes for service analysis may include fewer, additional, and/or a different arrangement of operations. For example, determining whether the recorder is activated may occur before determining whether the logon was successful. As another example, the logon failure may be processed before or during the creation of the database entry. As a further example, additional information may be inserted into the database during the execution of the application.

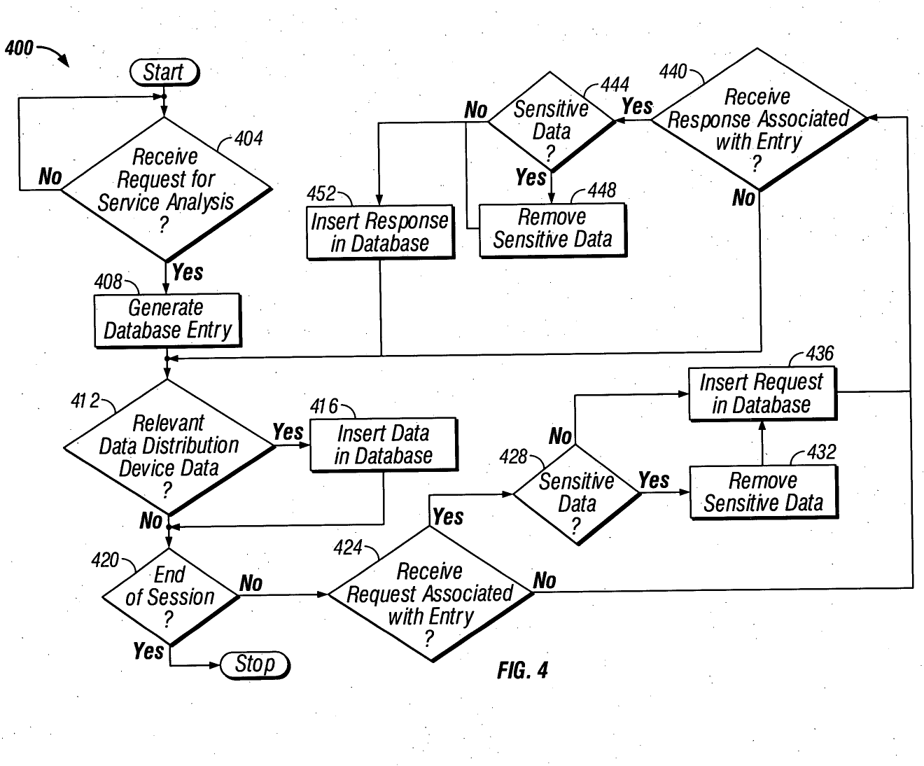

FIG. 4 illustrates a process 400 for service analysis. Process 400 may be implemented by a data distribution device similar to data distribution device 200 in FIG. 2; other data distribution devices, however, may also implement the process. The recording function of a data distribution device may already have been activated for process 400.

Process 400 begins with waiting to receive a request for service analysis of a session (decision block 404). The request may come from a remote computer, a local computer, a system administration module, or any other appropriate system component. The request may have been generated at the behest of a user of a service. Typically, the entity requesting service analysis must be authorized to use this function.

The process continues with creating an entry in a database (function block 408). The entry will be used to store data regarding the session under analysis. The data may include requests, responses, server state, and/or resource state. The database may be have a flat, a relational, a hierarchical, or any other appropriate relationship of data.

The process also calls for determining whether relevant data distribution device data is available (decision block 412). Relevant data distribution device data may include information about the path to the resource, the information passed to the resource, logon technique used, and/or any other appropriate information. If relevant data distribution device data is available, the process calls for inserting the data into the database (function block 416).

The process continues with determining whether the session has ended (decision block 420). Determining whether the session has ended may be accomplished by determining that a message indicating that the system component has terminated the session has been received, by determining that an error has occurred, by determining that a timeout occurred, or by determining that any other appropriate event has occurred. If the session has ended, the process is at an end.

If, however, the session has not ended, the process calls for determining whether a request associated with the entry has been received (decision block 424). A request may be associated with an entry by having an identifier (e.g., a client address or a session identifier) that is associated with the entry.

If a request associated with the entry has been received, the process calls for determining whether sensitive data is present in the request (decision block 428). Sensitive data may, for example, include a client user's personal information (e.g., social security number, credit card number, or personal identification number (PIN)) and may be located in the logon data of a request (i.e., the content of the request body may be uncontrolled). If sensitive data is present in the request, the process calls for removing the sensitive data from the request (function block 432). In certain implementations, the sensitive data may be replaced by blanks, dummy data, or master data. After the sensitive data has been removed from the request, or if no sensitive data is present in the request, the process calls for inserting the request into the database (function block 436).

After inserting the request into the database, or if a request associated with the entry have not been received, the process calls for determining whether a response associated with the entry has been received (decision block 440). A response may be associated with an entry by having an identifier (e.g., client address or session identifier) that is associated with the entry.

If a response associated with the entry has been received, the process calls for determining whether sensitive data is present in the response (decision block 444). Sensitive data may, for example, include a client user's personal information (e.g., social security number, credit card number, or personal identification number (PIN)). If sensitive data is present in the response, the process calls for removing the sensitive data from the response (function block 448). In certain implementations, the sensitive data may be replaced by blanks, dummy data, or master data. After the sensitive data has been removed from the response, or if no sensitive data is present in the response, the process calls for inserting the response into the database (function block 452).

After inserting the response into the database, the process calls for again determining whether relevant server data is available (decision block 412). The process continues to check for relevant server data, requests associated with the entry, and responses associated with the entry until the end of the session is reached.

Although FIG. 4 illustrates a process for service analysis, other processes for service analysis may include fewer, additional, and/or a different arrangement of operations. For example, checking for relevant server data, requests associated with an entry, and responses associated with an entry may occur in any order, and perhaps simultaneously. As a further example, a process may include operations for authentication and authorization of the service analysis request. As an additional, a process may include operations for establishing a session. As another example, a process may not call for removing sensitive data before inserting data into the database. As an additional example, a process may call for determining a recordation level and recording data in accordance with the determined level.

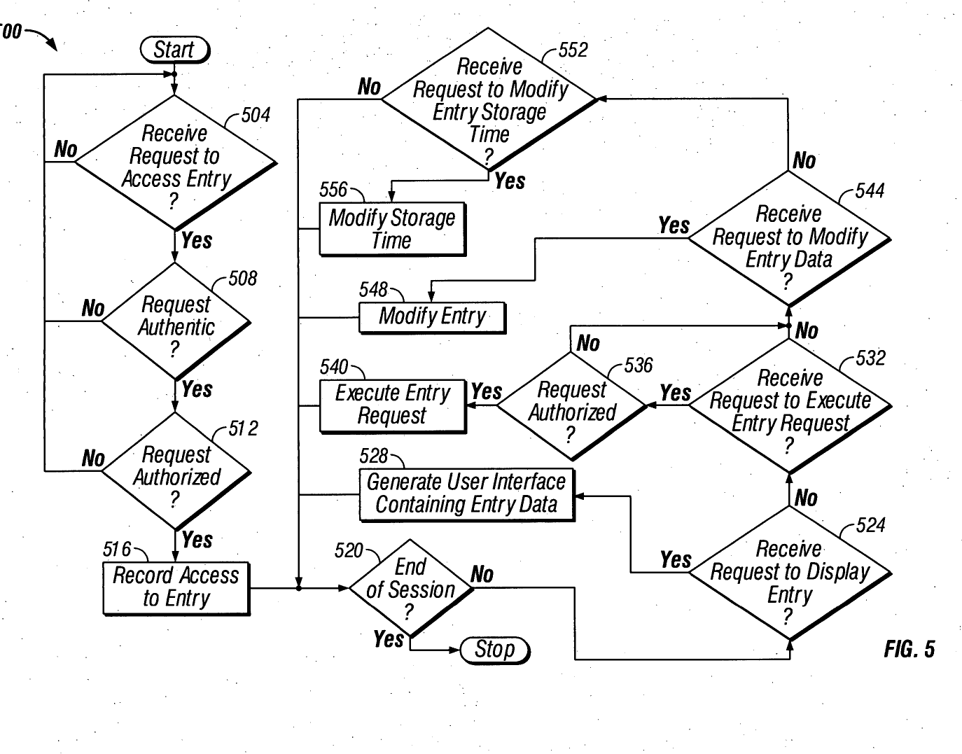

FIG. 5 illustrates a process 500 for service analysis. Process 500 may be implemented by a data distribution device similar to data distribution device 200 in FIG. 2; other devices, however, may also implement the process. Process 500 begins with waiting to receive a request to access an entry that contains data for service analysis of a session (decision block 504). The data may, for example, include a data distribution device state. The request may originate from a remote computing device, a local computing device, a system administration module, or any other appropriate system component.

The process continues with determining whether the access request is authentic (decision block 508). Determining whether a request is authentic may, for example, be accomplished by the use of X.509 certificates. If the request is not authentic, the process calls for returning to wait for a request to access an entry.

The process also calls for determining whether the access request is authorized (decision block 512). Determining whether a request is authorized may, for example, be accomplished by the use role-based assignments. If the request is not authorized, the process calls for returning to wait for a request to access an entry.

If, however, a valid request to access an entry is received, the process calls for recording the access to the entry (function block 516). Recording access to an entry may include storing a user identifier so that it is associated with the entry.

The process continues with determining whether the session has ended (decision block 520). Determining whether the session has ended may be accomplished by determining that a message indicating that the system component has terminated the session has been received, by determining that an error has occurred, by determining that a timeout has occurred, or by determining that any other appropriate event has occurred. If the session has ended, the process is at an end.

If, however, the session has not ended, the process calls for determining whether a request to display the entry has been received (decision block 524). If a request to display the entry has been received, the process calls for generating a user interface containing the entry data (function block 528). The user interface may, for example, be a graphical user interface that will be visually presented to a user. The process then calls for again determining whether the session has ended (decision block 520).

If, however, a request to display the entry has not been received, the process calls for determining whether a request to execute a request in the entry has been received (decision block 532). If a request to execute an entry request has been received, the process calls for determining whether the request is authorized (decision block 536). If the request is authorized, the process continues with executing the entry request (function block 540). After executing the entry request, the process calls for again determining whether the session has ended (decision block 520).

But if a request to execute an entry request has not been received, or if the request is not authorized, the process calls for determining whether a request to modify entry data has been received (decision block 544). Modification of the entry data may include modifying the content and other characteristics and attributes of a request in the entry data. If a request to modify entry data has been received, the process calls for modifying the entry data (function block 548). After modifying the entry data, the process calls for again determining whether the session has ended (decision block 520).

If, however, a request to modify entry data has not been received, the process calls for determining whether a request to modify entry storage time has been received (decision block 552). If a request to modify entry storage time has been received, the process calls for modifying the entry storage time (function block 556). After modifying the entry storage time, or if a request to modify entry storage time has not been received, the process calls for again determining whether the session has ended (decision block 520).

Although FIG. 5 illustrates a process for service analysis, other processes for service analysis may include fewer, additional, and/or a different arrangement of operations. For example, determining whether a request is authentic or authorized may occur in any order or may not occur at all. As another example, determining whether a request to modify an entry has been received may not occur. As another example, determinations may be made, and operations performed, regarding deletions, uploads, downloads, copies, or any other appropriate operations for an entry. Authorization determinations may also be made for each of these operations, as well as for the ones in FIG. 5.

The techniques described above can be implemented in digital electronic circuitry, or in computer hardware, firmware, software, or in combinations of them. The techniques also can be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Process operations of the techniques can be performed by one or more programmable processors executing a computer program by operating on input data and generating output. Operations can also be performed by, and apparatuses can be implemented as, special purpose logic circuitry, e.g., an FPGA (field programmable gate array) or an ASIC (application-specific integrated circuit). The process operations may also be performed in other orders than those described above.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The techniques can be implemented using a computing system that includes a back-end component, e.g., as a data server, or that includes a middleware component, e.g., an application server, or that includes a front-end component, e.g., a client computer having a graphical user interface or a Web browser through which a user can interact with an implementation of the techniques, or any combination of such back-end, middleware, or front-end components.

The invention has been described in terms of particular implementations. Other implementations are within the scope of the following claims.

1. A method for service analysis at a data distribution device, the method comprising:
receiving a request for service analysis of a session;
determining whether data relevant to the service analysis is available; and
if relevant data is available, inserting the relevant data in a specified memory.

2. The method of claim 1, wherein:
determining whether data relevant to the service analysis is available comprises determining whether a request for the session has been received; and
inserting the relevant data in a specified memory comprises inserting a request in the specified memory if a request for the session has been received.

3. The method of claim 2, further comprising:
determining whether the request comprises sensitive data; and
if the request comprises sensitive data, removing the sensitive data before inserting the request in the specified memory.

4. The method of claim 2, wherein the request comprises a Hypertext Transfer Protocol request.

5. The method of claim 1, wherein:
determining whether data relevant to the service analysis is available comprises determining whether a response for the session has been received; and
inserting the relevant data in a specified memory comprises inserting a response in the specified memory if a response for the session has been received.

6. The method of claim 5, further comprising:
determining whether the response comprises sensitive data; and
if the response comprises sensitive data, removing the sensitive data before inserting the response in the specified memory.

7. The method of claim 1, further comprising:
determining a level of recordation for the service analysis; and
inserting data for the service analysis into the specified memory based on the level.

8. The method of claim 1, further comprising:
receiving a request to access the inserted data;
determining whether a user associated with the request is authorized to access the inserted data; and
if a user associated with the request is authorized to access the inserted data, allowing access to the inserted data.

9. The method of claim 8, wherein allowing access to the inserted data comprises generating a user interface to display the inserted data.

10. The method of claim 8, wherein allowing access to the inserted data comprises allowing execution of a request in the inserted data.

11. The method of claim 8, wherein allowing access to the inserted data comprises allowing modification of a storage time for the inserted data.

12. The method of claim 8, wherein allowing access to the inserted data comprises allowing modification of the inserted data.

13. The method of claim 1, wherein relevant data comprises a state of the distribution data device.

14. An article comprising a machine-readable medium storing instructions operable to cause one or more machines to perform operations comprising:
determining whether a request for service analysis of a session has been received;
determining whether data relevant to the service analysis is available; and
if relevant data is available, inserting the relevant data in a specified memory.

15. The article of claim 14, wherein:
determining whether data relevant to the service analysis is available comprises determining whether a request for the session has been received; and
inserting the relevant data in a specified memory comprises inserting a request in the specified memory if a request for the session has been received.

16. The article of claim 15, wherein the instructions are further operable to cause one or more machines to perform operations comprising:
determining whether the request comprises sensitive data; and
if the request comprises sensitive data, removing the sensitive data before inserting the request in the specified memory.

17. The article of claim 14, wherein the instructions are further operable to cause one or more machines to perform operations comprising:
determining a level of recordation for the service analysis; and
inserting data for the service analysis into the specified memory based on the level.

18. The article of claim 14, wherein the instructions are further operable to cause one or more machines to perform operations comprising:
determining whether a request to access the inserted data has been received;
determining whether a user associated with the request is authorized to access the inserted data; and
if a user associated with the request is authorized to access the inserted data, allowing access to the inserted data.

19. The article of claim 18, wherein allowing access to the inserted data comprises allowing execution of a request in the inserted data.

20. The article of claim 18, wherein allowing access to the inserted data comprises allowing modification of a storage time for the inserted data.

21. The article of claim 18, wherein allowing access to the inserted data comprises allowing modification of the inserted data.

22. The article of claim 14, wherein relevant data comprises a state of the distribution data device.

23. A system for service analysis, the system comprising:
a service recorder operable to:
determine whether a request for service analysis of a session has been received;
determine whether data relevant to the service analysis is available; and
if relevant data is available, insert the relevant data in a specified memory.

24. The system of claim 23, wherein:
determining whether data relevant to the service analysis is available comprises determining whether a request for the session has been received; and
inserting the relevant data in a specified memory comprises inserting a request in the specified memory if a request for the session has been received.

25. The system of claim 24, wherein the recorder is further operable to:
determine whether the request comprises sensitive data; and
if the request comprises sensitive data, remove the sensitive data before inserting the request in the specified memory.

26. The system of claim 23, wherein the recorder is further operable to:
determine a level of recordation for the service analysis; and
insert data for the service analysis into the specified memory based on the level.

27. The system of claim 23, wherein the recorder is further operable to:
determine whether a request to access the inserted data has been received;
determine whether a user associated with the request is authorized to access the inserted data; and
if a user associated with the request is authorized to access the inserted data, allow access to the inserted data.

28. The system of claim 27, wherein allowing access to the inserted data comprises allowing execution of a request in the inserted data.

29. The system of claim 27, wherein allowing access to the inserted data comprises allowing modification of a storage time for the inserted data.

30. The system of claim 27, wherein allowing access to the inserted data comprises allowing modification of the inserted data.

31. The system of claim 23, wherein relevant data comprises a state of the distribution data device.

32. A method for service analysis at a data distribution device, the method comprising:
receiving a request to access service analysis data for a session;
determining whether a user associated with the request is authorized to access the data; and
if a user associated with the request is authorized to access the data, allowing access to the data.

33. The method of claim 32, wherein the data comprises a request for the session.

34. The method of claim 32, wherein the data comprises a data distribution device state.

35. The method of claim 32, wherein allowing access to the data comprises generating a user interface to display the inserted data.

36. The method of claim 32, wherein allowing access to the data comprises allowing execution of a request in the inserted data.

37. The method of claim 32, wherein allowing access to the data comprises allowing modification of the inserted data.

38. The method of claim 32, wherein allowing access to the data comprises allowing modification of a storage time for the data.

39. An article comprising a machine-readable medium storing instructions operable to cause one or more machines to perform operations comprising:
determining whether a request to access service analysis data for a session has been received;
determining whether a user associated with the request is authorized to access the data; and
if a user associated with the request is authorized to access the data, allowing access to the data.

40. The article of claim 39, wherein the data comprises a data distribution device state.

41. The article of claim 39, wherein allowing access to the data comprises allowing execution of a request in the inserted data.

42. The article of claim 39, wherein allowing access to the data comprises allowing modification of the inserted data.

43. The article of claim 39, wherein allowing access to the data comprises allowing modification of a storage time for the inserted data.

44. A method for service analysis at a data distribution device, the method comprising:
receiving a request for service analysis of an application session;
determining a recordation level for the service analysis;
determining whether data relevant to the service analysis is available, wherein relevant data comprises a Hypertext Transfer Protocol request for the session and a state of the data distribution device;
if data relevant to the service analysis is available, determining whether the data is in accordance with the recordation level;
if the data is in accordance with the recordation level, determining whether the relevant data comprises sensitive data;
if the relevant data comprises sensitive data, removing the sensitive data from the relevant data;
inserting the relevant data in a database location;
receiving a request to access the inserted data;
determining whether a user associated with the request is authorized to access the inserted data; and
if a user associated with the request is authorized to access the inserted data, allowing access to the inserted data, wherein allowing access comprises:
generating a user interface to display the inserted data;
allowing execution of a request in the inserted data;
allowing modification of a storage time for the inserted data; and
allowing modification of the inserted data.
